(19) United States
(12) Patent Application Publication
(10) Pub. No.: US 2025/0203481 A1
(43) Pub. Date: Jun. 19, 2025

(54) QOS MANAGEMENT FOR WIRELESS NETWORK

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US)

(21) Appl. No.: 18/970,754

(22) Filed: Dec. 5, 2024

Related U.S. Application Data
(60) Provisional application No. 63/611,379, filed on Dec. 18, 2023.
(60) Provisional application No. 63/691,731, filed on Sep. 6, 2024.

(51) Int. Cl. H04W 36/26; H04W 36/00; H04W 36/24

(52) U.S. Cl. CPC H04W 36/26; H04W 36/0044; H04W 36/249

(57) ABSTRACT

A station (STA) in a wireless network that is configured to transfer an established stream classification service (SCS) agreement with an access point (AP) to a different AP while roaming, including transmitting a frame that causes the transfer to an AP, receiving a response from the AP regarding whether the transfer to the different AP has been accepted, declined, or conditionally accepted with a set of alternative parameters for the SCS agreement, and the STA seamlessly roaming to the different AP while maintaining the established SCS agreement for the network traffic and without having to establish a new SCS agreement.

### CROSS-REFERENCE TO RELATED APPLICATION(S)

This application claims the benefit of priority from U.S. Provisional Application No. 63/611,379, entitled “QOS TRANSFER FOR NEXT GENERATION WLANS” filed Dec. 18, 2023; and U.S. Provisional Application No. 63/691,731, entitled “SCS HANDLING UNDER ROAMING FOR NEXT GENERATION WI-FI” filed Sep. 6, 2024, all of which are incorporated herein by reference in their entireties.

### TECHNICAL FIELD

This disclosure relates generally to a wireless communication system, and more particularly to, for example, but not limited to, quality of service (QOS) management during roaming for wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

To be determined by Attorney after Claims reviewed] One aspect of the present disclosure provides a station (STA) in a wireless network, comprising: a memory; and a processor coupled to the memory. The processor is configured to transmit, to a first access point (AP), a first frame that causes a transfer, from the first AP to a second AP, information associated with a stream classification service (SCS) agreement. The processor is configured to receive, from the first AP, a second frame that includes a response to the first frame. The processor is configured to switch to the second AP based on the second frame. The processor is configured to transmit, to the second AP, one or more frames according to the transferred information associated with the SCS agreement

In some embodiments, the SCS agreement includes quality of service (QOS) characteristics for traffic of the STA or one or more information items in a traffic classifier (TCLAS) element.

In some embodiments, the second frame indicates a time during which the STA switches to the second AP.

In some embodiments, the processor is further configured to transmit, to the first AP, a frame indicating that the STA is capable of setting up or initiating a transfer of information associated with the SCS agreement.

In some embodiments, the first frame indicates that the information associated with the SCS agreement can be transferred or requests that the information associated with the SCS agreement be transferred to the second AP

In some embodiments, the second frame indicates that the information associated with the SCS agreement has been transferred or that the information associated with the SCS agreement will be transferred upon roam.

In some embodiments, the second frame indicates that the information associated with the SCS agreement has not been transferred, wherein the processor is further configured to establish a different SCS agreement with the second AP upon roam.

In some embodiments, the processor is further configured to receive, from the first AP, a frame indicating that the first AP is capable of transferring the information associated with the SCS agreement as part of roaming.

One aspect of the present disclosure provides a first access point (AP) in a wireless network, comprising a memory; and a processor coupled to the memory. The processor is configured to receive, from a station (STA), a first frame that causes a transfer, from the first AP to a second AP, information associated with a stream classification service (SCS) agreement. The processor is configured to transfer, to the second AP, the information associated with the SCS agreement. The processor is configured to transmit, to the STA, a second frame that includes a response to the first frame.

In some embodiments, the SCS agreement includes quality of service (QOS) characteristics for traffic of the STA or one or more information items in a traffic classifier (TCLAS) element.

In some embodiments, the second frame indicates a time during which the STA switches to the second AP.

In some embodiments, the processor is further configured to transmit, to the STA, a frame indicating that the first AP is capable of setting up or initiating a transfer of the information associated with the SCS agreement.

In some embodiments, the first frame indicates that the information associated with the SCS agreement can be transferred or requests that the information associated with the SCS agreement be transferred to the second AP.

In some embodiments, the second frame indicates that the information associated with the SCS agreement has been transferred or that the information associated with the SCS agreement will be transferred upon roam.

In some embodiments, the second frame indicates that the information associated with the SCS agreement has not been transferred.

In some embodiments, the processor is further configured to transmit, to the STA, a frame indicating that the first AP is capable of transferring the information associated with the SCS agreement as part of roaming.

One aspect of the present disclosure provides a first access point (AP) in a wireless network, comprising a memory; and a processor coupled to the memory. The processor is configured to receive, from a second AP, a first frame that causes a transfer, from the second AP to the first AP, information associated with a stream classification service (SCS) agreement between the second AP and a station (STA). The processor is configured to transmit, to the second AP, a second frame that includes a response to the first frame. The processor is configured to receive, from the STA, one or more frames according to the transferred information associated with the SCS agreement.

In some embodiments, the SCS agreement includes quality of service (QOS) characteristics for traffic of the STA or one or more information items in a traffic classifier (TCLAS) element.

In some embodiments, the second frame indicates a time during which the STA switches from the second AP to the first AP.

In some embodiments, the second frame accepts the transfer of the information associated with the SCS agreement.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates stages of a mobility handover procedure in accordance with an embodiment.

FIG. 5 illustrates a logical AP multi-link device (MLD) in accordance with an embodiment.

FIG. 6 illustrates a Stream Classification Service (SCS) request frame in accordance with an embodiment.

FIG. 7 illustrates a SCS request and response exchanges in accordance with an embodiment.

FIG. 8 illustrates SCS transfer prior to roam in accordance with an embodiment.

FIG. 9 illustrates SCS transfer during roaming in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

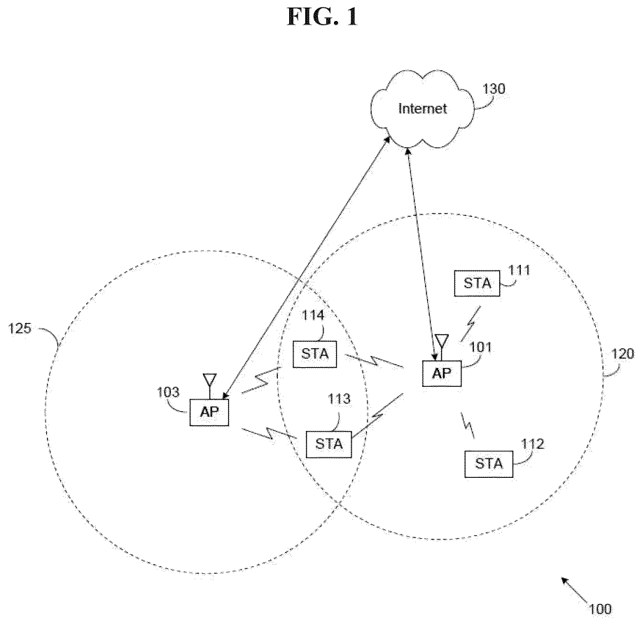

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

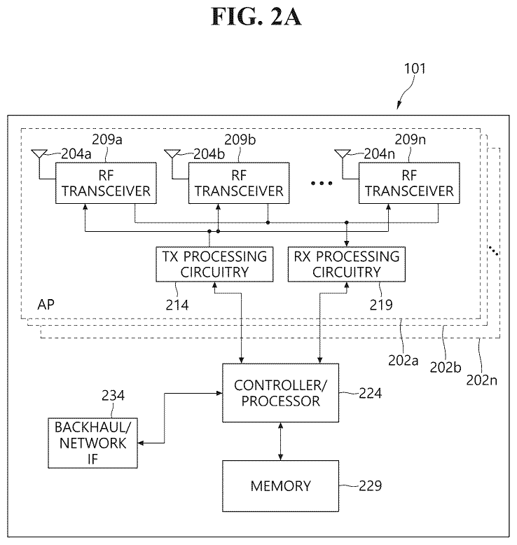

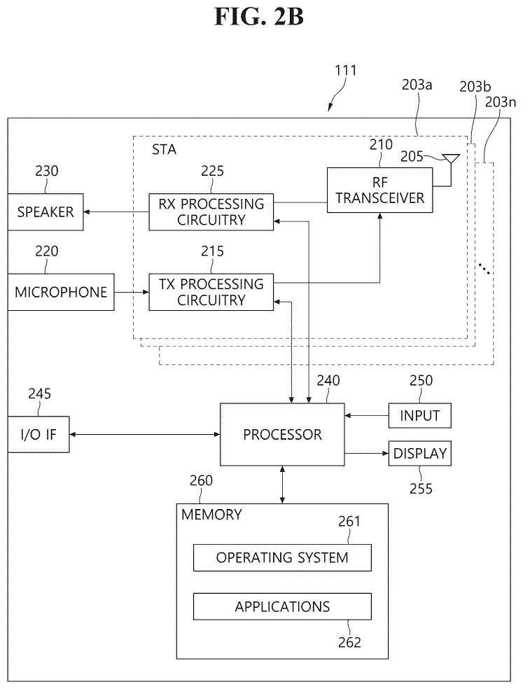

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

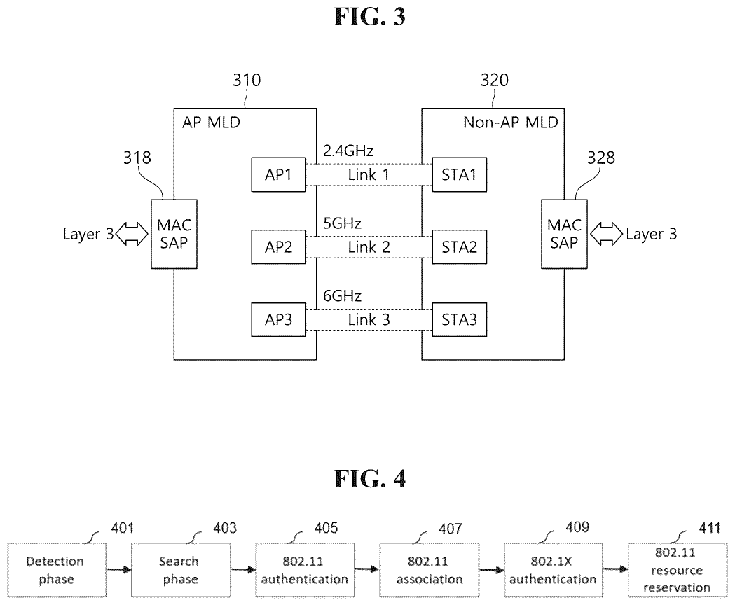

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D4.0, “Wireless LAN Medium Access Control (MAC) and Physical Layer (PHY) Specifications.”

As users move around an environment while holding an STA device, a signal strength of the STA to its connected AP can vary. If a user movement causes a significant decrease in a signal strength, a handover may be necessary. During the process of handover, an STA may switch from its current associated AP to a new AP. As described herein, the IEEE 802.11xx standards may be referred to as 802.11xx for short.

FIG. 4 illustrates stages of a mobility handover procedure in accordance with an embodiment. As shown in FIG. 4, in legacy devices without any mobility support, the handover procedure may involve several steps, including a detection phase 401, a search phase 403, an 802.11 authentication phase 405, an 802.11 association phase 407, an 802.1X authentication phase 409, and an 802.11 resource reservation phase 411.

During the detection phase 401, an STA may determine that there is a need for a handover. The procedures to detect a need for handover may be vendor specific. For instance, a particular vendor implementation can choose to trigger handover when the signal strength to the currently associated AP drops below a certain threshold.

The detection phase 401 may be followed by a search phase 403. During the search phase 403, the STA may search for new APs to associate with. During the search phase 403, the STA may perform a scan of different channels to identify APs in the vicinity. This can be done either passively (e.g., listening to beacons on a particular channel) or actively (e.g., by the use of probe request and response procedure).

After the scanning procedure is complete, the next step is to perform 802.11 authentication (open system/shared key based) 405. Once the STA is authenticated, the next step is to perform 802.11 association 807. Introduced in IEEE 802.11i amendment, the 802.1X authentication phase 409 may include an EAP authentication between the STA and a AAA server with the assistance of the AP. Finally, during the 802.11 resource reservation phase 411, the STA may set up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures may be to remove or reduce the delay encountered in various steps of the handover procedure. In 2008, IEEE 802.11r standard introduced a fast transition roaming which may eliminate the need for the authentication step during the handover. In 2011, IEEE 802.11k introduced assisted roaming which reduces the search phase by allowing the STA to request the AP to send channel information of candidate neighbor APs. In 2011, IEEE 802.11v also introduced network assisted roaming to assist the search phase. In IEEE 802.11be, the fast BSS transition procedure was extended to cover the case of MLO operation. This procedure helps to reduce the delays encountered due to 802.11 resource reservation. However, the STA may still need to perform the association and authentication phases which can take e.g., 10s of ms.

In next generation WLANs, low-latency with high reliability support has been targeted. In order to meet this goal, the concept of a logical AP MLD can be considered.

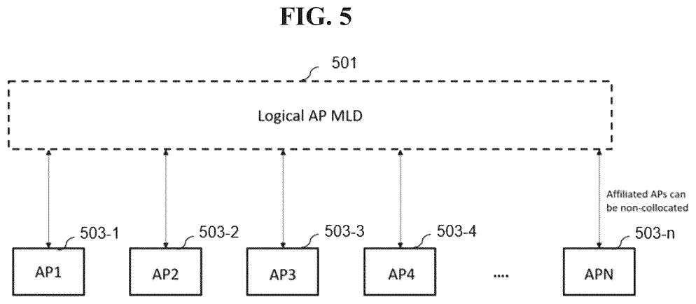

FIG. 5 illustrates a logical AP MLD in accordance with an embodiment. As illustrated in FIG. 5, a logical AP MLD 501 can be made up of a plurality of APs, including AP1 503-1, AP2 503-2, AP3 503-3, AP4 504-4 to APN 504-n, which can be non-collocated. This may be different from the concept of AP MLD in IEEE 802.11be which considers collocated APs affiliated with an AP MLD. Further, one or more of these APs 503 can have a common data path to a router or a central controller. The APs 503 shown in FIG. 5 can form a logical AP MLD 501. This concept of AP MLD may reduce the delays of association and authentication steps mentioned above as the STA may not need to perform association and authentication during handover.

In some embodiments, a logical AP MLD can be used for a number of purposes besides mobility management such as multi-AP coordination, relay operation, among other applications. The logical AP MLD can be any kind of AP MLD where a coordination mechanism exists between the different APs (for example, non-collocated AP MLD, SMD, among others).

An STA may setup a Stream Classification Service (SCS) with its current AP. SCS may enable the STA to specify a number of parameters that may be useful for scheduling in order to handle the traffic of the STA. For example, the STA can provide a QoS treatment that can be applied to its traffic which can guide the AP's scheduler. In another example, the STA can also provide classification criteria in the SCS to enable the AP to identify a stream and understand relative priorities of streams within an Access Category (AC).

When a STA roams from one AP to another, the SCS session that it has setup with the current AP can be lost and the STA may need to re-setup another SCS stream with the target AP. This can cause a number of issues. For example, the target AP may not accept the same SCS parameters as the current AP of the STA. For example, if the current AP has accepted a delay bound of 30 ms, the target AP may reject the value and instead accept a delay bound of 50 ms, which may not be suitable for the STA's traffic. In another example, when the STA negotiates a new SCS with the target AP, it may need to perform several negotiations. During this time, the STA's application may not receive the QoS treatment that it used to receive with the previous AP. This can impact the application's performance.

In a logical AP MLD setup, when a STA or non-AP MLD undergoes handover from one physical AP MLD to another physical AP MLD, it may need to be able to transfer its SCS session or QoS related negotiation to the target AP MLD. Embodiments in accordance with this disclosure provide procedures to enable such transfers.

In some embodiments, when a non-AP MLD undergoes transition from one physical AP MLD to another physical AP MLD, the non-AP MLD can transmit a transfer message to the logical AP MLD that can include at least one or more of the information items as indicated in Table 1.

TABLE 1

| Information | |
|---|---|
| item | Description |
| Existing link | An information item that can indicate the existing link(s) on which one or |
| indication | more QoS agreements have been setup. |
| New link | An information item that can indicate the new link(s) on which one or |
| indication | more of the previously setup QoS agreements can be transferred to. |
| Transfer time | An information item that can indicate the time at which the transfer can |
| | take place. e.g., the number of Target Beacon Transmission Times |
| | (TBTTs) from the current TBTT at which the transfer can take place, |
| | time duration, etc. |
| Stream | An information item that can indicate the stream identifiers corresponding |
| identifiers | to those streams whose QoS agreements can be transferred. e.g., SCS ID. |
| Traffic | An information item that can indicate the traffic identifiers (TIDs) |
| identifiers | corresponding to those traffic streams whose QoS agreements can be |
| | transferred. e.g., TIDs. |
| QoS | An information item that can indicate the QoS agreement(s) that need to be |
| information | transferred over. e.g., QoS characteristic element, SCS request frames, etc. |
| Mapped link | An information item that can indicate the link(s) in the new physical AP |
| indication | MLD to which the QoS agreements need to be assigned or mapped to. |
| QoS transfer | An information item that can indicate that this message is transmitted to |
| indicator | perform transfer of QoS agreements. e.g., a unique identifier or value that is |
| | predetermined by the specification. |
| Request | An information item that can indicate the identifier for the request message. |
| identifier | e.g., dialog token. |

The above information items can be transmitted together or separately. They can be transmitted as a part of any existing frame or element or field or subfield in the standard or can be a part of newly defined ones.

In some embodiments, upon receiving a request transfer message, the indicated QoS agreements can be transferred to the new AP MLD at the indicated time. In some embodiments, upon receiving the request transfer message, the receiver can generate a response message. The response message can include at least one or more of the information items as indicated in Table 2.

TABLE 2

| Information | |
|---|---|
| item | Description |
| Existing link | An information item that can indicate the existing link(s) on which one or |
| indication | more QoS agreements have been setup. |
| New link | An information item that can indicate the new link(s) on which one or more |
| indication | of the previously setup QoS agreements can be transferred to. |
| Transfer time | An information item that can indicate the time at which the transfer can take |
| | place. e.g., the number of TBTTs from the current TBTT at which the transfer |
| | can take place, time duration, etc. |
| Stream | An information item that can indicate the stream identifiers corresponding to |
| identifiers | those streams whose QoS agreements can be transferred. e.g., SCS ID. |
| Traffic | An information item that can indicate the traffic identifiers (TIDs) |
| identifiers | corresponding to those traffic streams whose QoS agreements can be |
| | transferred. e.g., TIDs. |
| QoS | An information item that can indicate the QoS agreement(s) that need to be |
| information | transferred over. e.g., QoS characteristic element, SCS request frames, etc. |
| Mapped link | An information item that can indicate the link(s) in the new physical AP |
| indication | MLD to which the QoS agreements can be assigned or mapped to. |
| QoS transfer | An information item that can indicate that this message transmitted to |
| indicator | perform transfer of QoS agreements. e.g., a unique identifier or value that is |
| | predetermined by the specification. |
| Request | An information item that can indicate the identifier for the request message. |
| identifier | E.g., dialog token. |
| Status | An information item that can indicate the status of the request. e.g., reason |
| information | code to indicate if the receiver has rejected the request or accepted the |
| | request. |

The above information items can be transmitted together or separately. They can be transmitted as a part of any existing frame or element or field or subfield in the standard or can be a part of newly defined ones.

In some embodiments, when a non-AP MLD wants to undergo a transition from the current AP MLD to a new AP MLD, the non-AP MLD can make a request to transfer its existing QoS agreements to the new AP MLD. Upon making the request, the non-AP MLD can wait for a response and upon a confirmation or approval of the request, at the indicated time, the QoS agreements can be considered to be transferred to the new AP MLD. In some embodiments, if a response is not needed or is not expected, then the QoS agreement can be considered to be transferred to the new AP MLD at the indicated time.

In some embodiments, when an AP MLD receives a request, it can process the request and generate a response depending on the feasibility of the request. If the request is approved, then the AP MLD can transmit a response with an approval. If the request is rejected, then the AP MLD can transmit a response with the rejection indication. At the indicated time, the QoS agreements can be transferred over to the new AP MLD.

In some embodiments, an AP MLD can also transmit an unsolicited response message if it wants to transfer the non-AP MLD to another physical AP MLD of the logical AP MLD. For example, if the signal strength to the non-AP MLD is weak. In some embodiments, the AP MLD can determine the QoS agreements that can be transferred over to the new physical AP MLD and can make an indication of those agreements in the response frame.

In some embodiments, if one or more agreements are not setup via a transfer procedure, then the non-AP MLD can either attempt to set them up before the transition occurs or can perform the setup after the transition occurs.

In some embodiments, a SCS or QoS agreement can be setup with the target AP MLD or target AP prior to the transition procedure. In some embodiments, prior to the transition procedure, the non-AP MLD can transmit a request message that can include at least one or more of the information items as indicated in Table 3.

TABLE 3

| Information | |
|---|---|
| item | Description |
| Stream | An information item that can indicate the stream identifiers for those streams |
| identifiers | for whom QoS agreements need to be setup. e.g., SCS ID. |
| Action | An information item that can indicate the action that needs to be taken for |
| identifier | these streams. E.g., add, remove, change the agreements. |
| Stream | An information item that can indicate the classification criteria that can be |
| classification | used to identify the streams. e.g., Traffic Classification (TCLAS) elements |
| criteria | along with TCLAS processing elements. |
| QoS | An information item that can indicate the QoS information. e.g., QoS |
| information | characteristic element. |
| Link | An information item that can indicate the link(s) for which the above |
| identifier | agreement(s) can be applicable for. |
| Setup time | An information item that can indicate the time before which the setup can |
| | take place. e.g., the number of TBTTs from the current TBTT at which the |
| | above agreement can take effect. |

The above information items can be transmitted together or separately. They can be transmitted as a part of any existing frame or element or field or subfield in the standard (e.g., modified SCS request) or can be a part of newly defined ones

Upon receiving the request message, the AP MLD can process the request and can generate a response message that can include at least one or more of the information items as indicated in Table 4.

TABLE 4

| Information | |
|---|---|
| item | Description |
| Stream | An information item that can indicate the stream identifiers for those streams |
| identifiers | for whom QoS agreements can be setup. e.g., SCS ID. |
| Action | An information item that can indicate the action that has been taken for these |
| identifier | streams. e.g., add, remove, change the agreements. |
| Stream | An information item that can indicate the classification criteria that can be |
| classification | used to identify the streams. e.g., TCLAS elements along with TCLAS |
| criteria | processing elements. This can also be optionally skipped. |
| QoS | An information item that can indicate the QoS information. e.g., QoS |
| information | characteristic element. This can also be optionally skipped. |
| Link | An information item that can indicate the link(s) for which the above |
| identifier | agreement(s) can be applicable for. |
| Setup time | An information item that can indicate the time before which the setup can |
| | take place. e.g., the number of TBTTs from the current TBTT at which the |
| | above agreement can take effect. |

The above information items can be transmitted together or separately. They can be transmitted as a part of any existing frame or element or field or subfield in the standard (e.g., modified SCS request) or can be a part of newly defined ones.

In some embodiments, when the non-AP MLD transmits a request message, it can wait for the response message. Upon receiving the response message, the non-AP MLD can consider that the QoS agreements have been setup on the new link(s) and can take effect at the indicated time.

In some embodiments, when an AP MLD receives a request message, the AP MLD can process the request message and can generate a response message as per the feasibility. At the indicated time, the QoS agreements can go into effect on the new link(s).

In some embodiments, the initiator can be the non-AP MLD. The non-AP MLD can initiate a transfer of existing QoS agreements or setup of new QoS agreements with the new physical AP MLD. The non-AP MLD can start these processes prior to the transition so that upon transition, the agreements go into effect. The non-AP MLD can transmit the request messages to its current physical AP MLD or to the target physical AP MLD (e.g., as part of the messages transmitted during the transition to the target physical AP MLD).

In some embodiments, the current physical AP MLD can also assist in this procedure. The current physical AP MLD can also act as an initiator and can assist in the transfer or setup of QoS agreements with the target physical AP MLD. In some embodiments, if the current AP MLD becomes aware of the non-AP MLD's intent to transition to the new physical AP MLD, then the current AP MLD can initiate a transfer or setup procedure on behalf of the non-AP MLD. The non-AP MLD can also indicate to the current AP MLD if it can do so via an indication message or the current AP MLD can also seek permission from the non-AP MLD via a permission seeking message.

In some embodiments, the target physical AP MLD can also act as an initiator. In some embodiments, if the target AP MLD detects a non-AP MLD's transition to itself, then it can initiate a QoS transfer procedure on behalf of the non-AP MLD.

In some embodiments, the non-AP MLD or STA can transmit an SCS request to its current AP and indicate the candidate or target AP MLD(s) that the non-AP MLD or STA wants to set up an SCS agreement with. The request type can be set to a value that indicates to the current AP that the SCS agreement is for the target AP MLD. The current AP can then transmit the SCS request to the candidate or target AP MLD(s). This can be done by transmitting the request over the distribution system (DS).

In some embodiments, when the candidate or target AP MLD(s) receive the request, they can generate and transmit an SCS response to the current AP MLD. The current AP MLD may then forward the response to the non-AP MLD.

In some embodiments, when an SCS is setup, the non-AP MLD can include a roaming request indication message. The roaming request indication message can inform the current AP MLD about the candidate or target AP MLD(s) that the STA wants to setup the SCS with. When the AP sends an SCS response, it can include an indication of which candidate or target AP MLD(s) the response is coming from.

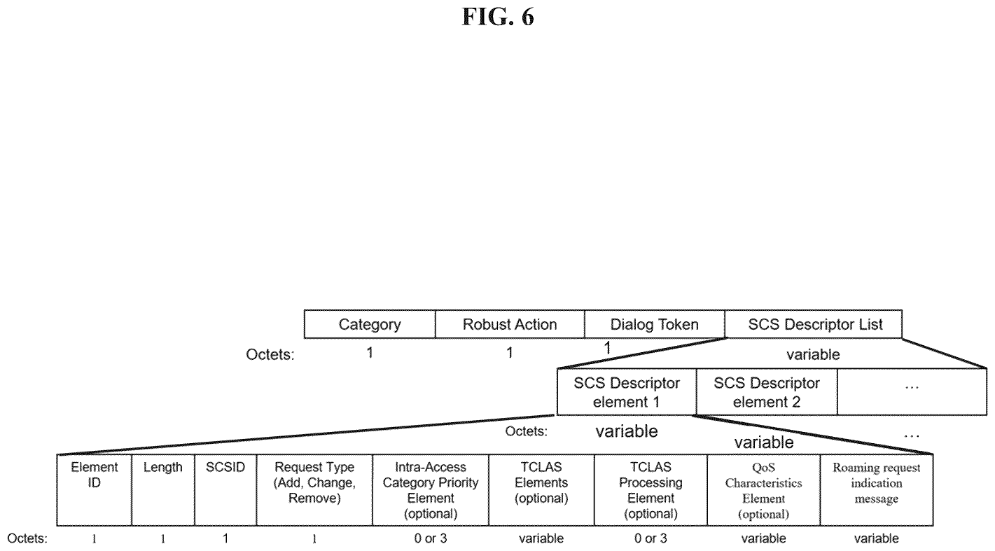

FIG. 6 illustrates an SCS request frame in accordance with an embodiment. The frame can include a Category field, a Robust Action field, a Dialog Token field, and an SCS descriptor list field.

The Category field may be set to a value that indicates a category of the SCS request frame that is an action frame. The Robust Action field may have a value associated with the SCS request frame format within predefined robust AV streaming category. The Dialog Token field may be used for matching action response with action requests when there are multiple, concurrent action requests. The SCS Descriptor List field may include one or more SCS Descriptor elements.

In particular, the SCS Descriptor element can include an Element ID field, Length field, SCSID field, Request Type field, Intra-Access Category Priority element field (optional), TCLAS elements field (optional), TCLAS processing element field (optional), QoS Characteristics element field (optional), and a Roaming Request Indication Message field.

The Element ID field may include information to identify a type of the SCS Descriptor element. The Length field may indicate a length of the SCS Descriptor element. The SCSID field may include information to identify the SCS descriptor element. The Request Type field can be set to indicate the request type (i.e., Add, Remove, and Change) of the SCS descriptor element. In some embodiments, the Request Type field may indicate that the SCS request is for another AP. In some embodiments, the Request Type field can be set to a value that indicates to the current AP that the SCS agreement is for the target AP. The current AP can then transmit the SCS request to the candidate or target AP MLD(s). In some embodiments, a presence of a roaming request indication message may act as an implicit indication.

The Intra-Access Category Priority element field may be present when the Request Type field is equal to “Add” or “Change.” The TCLAS element field may include information on a traffic classification. The TCLAS processing element field may include information on a method of processing a traffic from an upper layer. The QoS Characteristics element field may include a set of parameters that define the characteristics and QoS expectations of a traffic flow. The Roaming Request Indication Message field may include a list of candidate or target AP or AP MLD(s).

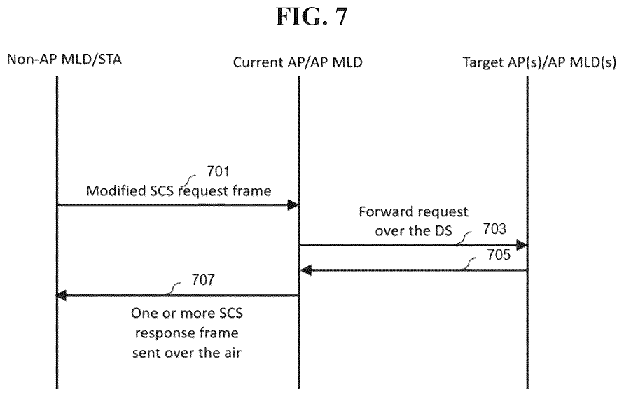

FIG. 7 illustrates a SCS request and response exchanges in accordance with an embodiment. Although one or more operations are described or shown in particular sequential order, in other embodiments the operations may be rearranged in a different order, which may include performance of multiple operations in at least partially overlapping time periods. In particular, FIG. 7 illustrates communication between a non-AP MLD or STA, a current AP or AP MLD, and a target AP(s) or AP MLD(s).

In operation 701, the non-AP MLD or STA transmits to the current AP or AP MLD a modified SCS request frame. In some embodiments, the non-AP MLD or STA can transmit an SCS request to its current AP and indicate the candidate or target AP MLD(s) that the non-AP MLD or STA wants to set up an SCS agreement with. The request type can be set to a value that indicates to the current AP that the SCS agreement is for the target AP MLD.

In operation 703, the current AP or AP MLD forwards to the Target AP(s) or AP MLD(s), the request over the DS. In some embodiments, the current AP or AP MLD can forward the SCS request to the target AP(s) or AP MLD(s) over the DS.

In operation 705, the target AP(s) or AP MLD(s) transmit to the current AP or AP MLD a response message. In some embodiments, the target AP(s) or AP MLD(s) can generate and transmit an SCS response to the current AP or AP MLD.

In operation 707, the current AP or AP MLD can forward to the non-AP MLD or STA one or more SCS response frames that are sent over the air. In some embodiments, when the AP or AP MLD sends an SCS response, it can include an indication of which target AP(s) or AP MLD(s) the response is coming from.

In some embodiments, a pre-roam setup can inform the non-AP MLD or STA about the feasibility of obtaining the same or preferred SCS agreement with other AP(s) or AP MLD(s). This information can serve as an input to an AP selection algorithm.

In some embodiments, the elements present in the SCS descriptor in FIG. 6 except the roaming request indication message can also be absent. The non-AP MLD or STA can indicate the SCS session that needs to be transferred by using the SCS ID alone.

In some embodiments, the SCS agreement with the current AP can be transferred to the target AP. In some embodiments, prior to roaming, the non-AP MLD or STA can request the current AP to attempt to transfer its SCS session to another AP MLD or AP. The non-AP MLD can indicate the list of AP MLD or AP to the current AP. The current AP MLD or AP can then communicate with the candidate or target AP MLD(s) over the DS and attempt to transfer the SCS session. The candidate or target AP MLD(s) can then inform the current AP MLD about their decision to accept or reject the current SCS session. If the candidate or target AP MLD(s) accept the current SCS session, they can provide an expiration time for the acceptance. After the expiration, the candidate or target AP MLD(s) may not be committed to the SCS session and the non-AP MLD or STA may need to re-setup the SCS again if it roams after the expiration time.

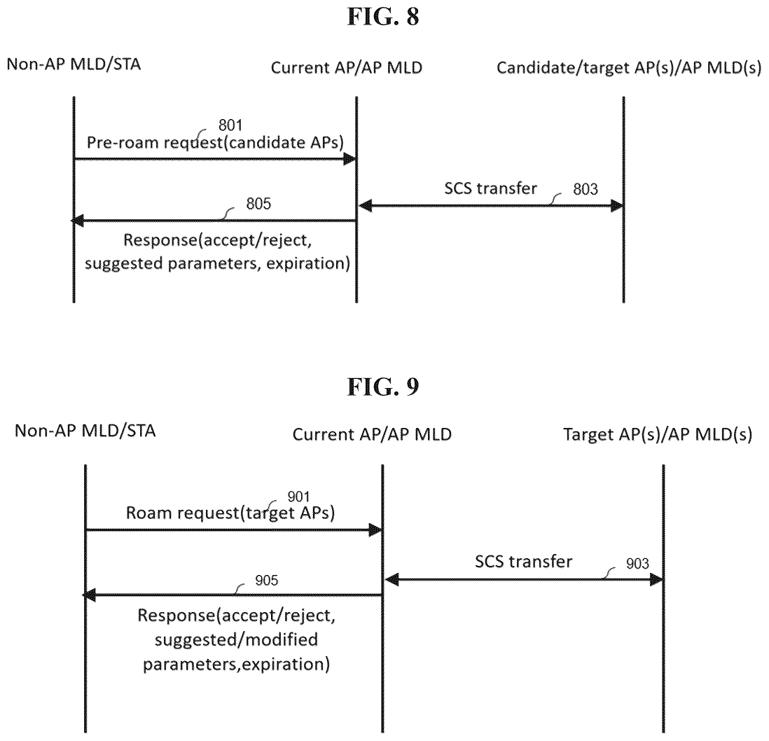

FIG. 8 illustrates SCS transfer prior to roam in accordance with an embodiment. Although one or more operations are described or shown in particular sequential order, in other embodiments the operations may be rearranged in a different order, which may include performance of multiple operations in at least partially overlapping time periods. In particular, FIG. 8 illustrates communication between a non-AP MLD or STA, a current AP or AP MLD, and a candidate or target AP(s) or AP MLD(s).

In operation 801, the non-AP MLD or STA transmits to the current AP or AP MLD a pre-roam request that includes candidate APs.

In operation 803, the current AP or AP MLD exchanges with the candidate or target AP(s) or AP MLD(s) SCS transfer messages. In some embodiments, the current AP or AP MLD can communicate with the candidate or target AP(s) or AP MLD(s) over the DS and attempt to transfer the SCS session. The candidate or target AP(s) or AP MLD(s) can then inform the current AP or AP MLD about their decision to accept or reject the current SCS session.

In operation 805, the current AP or AP MLD transmits to the non-AP MLD or STA one or more response messages that includes various information (e.g., accept or reject, suggested parameters, and or expiration information).

In some embodiments, the SCS agreement can be transferred during the roaming phase. In some embodiments, the current AP MLD or AP can transfer the SCS agreement to the target AP MLD or AP and indicate to the non-AP MLD or STA if the agreement has been transferred or not. If the agreement has been transferred, then the STA can expect to receive the same treatment at the target AP MLD. If the agreement has been declined, the STA may need to setup a new agreement with the target AP MLD.

FIG. 9 illustrates SCS transfer during roaming in accordance with an embodiment. Although one or more operations are described or shown in particular sequential order, in other embodiments the operations may be rearranged in a different order, which may include performance of multiple operations in at least partially overlapping time periods. In particular, FIG. 9 illustrates communication between a non-AP MLD or STA, a current AP or AP MLD, and a target AP(s) or AP MLD(s).

In operation 901, the non-AP MLD or STA transmits to the current AP or AP MLD a roam request message that includes target APs information. In some embodiments, the non-AP MLD or STA can transmit an SCS request to its current AP or AP MLD and indicate the target APs that the non-AP MLD or STA wants to transfer an SCS agreement with. The request type can be set to a value that indicates to the current AP that the SCS agreement is for the target AP MLD.

In operation 903, the current AP or AP MLD exchanges with the target AP(s) or AP MLD(s) SCS transfer messages.

In operation 905, the current AP or AP MLD transmits to the non-AP MLD or STA a response message that includes various information (e.g., accept, reject, suggested or modified parameters, and/or expiration information).

In some embodiments, when the candidate or target AP MLD or AP rejects an SCS agreement, it can provide a suggested set of parameters in the SCS agreement (e.g., delay bound) that it can accept. This information can serve as an input to the STA side AP selection algorithm. It can also help the STA to reduce the number of negotiations after roam if it needs to reset up an SCS with the new AP.

In some embodiments, an AP MLD that supports a handover (e.g., transfer of SCS and or QoS agreements or setup of new agreements) can make an indication of the support in one or more frames that it transmits (e.g., management frames such as beacons, probe responses, among others). This can make the non-AP MLD aware of the availability of this feature at the current or target AP MLD.

In some embodiments, a non-AP MLD that supports a handover (e.g., transfer of SCS and/or QoS agreements or setup of new agreements) can make an indication of the support in one or more frames that it transmits (e.g., management frames such as probe requests, (Re) association requests, among others). This can make the AP MLD aware of the fact that the non-AP MLD can make requests for QoS transfer during transition.

In some embodiments, a QoS agreement can be applicable to the entire MLD instead of one or more links. Thus, as the non-AP MLD transitions to a new set of links the same QoS agreement can be used.

In some embodiments, when a non-AP MLD makes a QoS agreement, there can be a negotiation about the link(s) of the AP MLD for which the QoS agreement can be applicable for. The non-AP MLD can then negotiate QoS agreements for link(s) of neighboring physical AP MLDs which are a part of the logical AP MLD in anticipation of transitioning over to those AP MLDs in the future.

In some embodiments, there can be a default QoS agreement for each traffic identifier (TID) or SCS ID and when a transition occurs, the default QoS agreement can be applicable until a new QoS agreement is not put in place.

Embodiments in accordance with this disclosure may be applicable to single link operation as well and are not necessarily limited to multi-link operation.

Embodiments in accordance with this disclosure may perform a handover procedure, whereby low latency application traffic may get a necessary QoS treatment during roaming, providing an improve user experience especially with multimedia services which can suffer from session disruptions due to the high delay encountered during existing handover procedure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of”′ preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to:
transmit, to a first access point (AP), a first frame that causes a transfer, from the first AP to a second AP, information associated with a stream classification service (SCS) agreement;
receive, from the first AP, a second frame that includes a response to the first frame;
switch to the second AP based on the second frame; and
transmit, to the second AP, one or more frames according to the transferred information associated with the SCS agreement.

2. The STA of claim 1, wherein the SCS agreement includes quality of service (QOS) characteristics for traffic of the STA or one or more information items in a traffic classifier (TCLAS) element.

3. The STA of claim 1, wherein the second frame indicates a time during which the STA switches to the second AP.

4. The STA of claim 1, wherein the processor is further configured to transmit, to the first AP, a frame indicating that the STA is capable of setting up or initiating a transfer of information associated with the SCS agreement.

5. The STA of claim 1, wherein the first frame indicates that the information associated with the SCS agreement can be transferred or requests that the information associated with the SCS agreement be transferred to the second AP.

6. The STA of claim 1, wherein the second frame indicates that the information associated with the SCS agreement has been transferred or that the information associated with the SCS agreement will be transferred upon roam.

7. The STA of claim 1, wherein the second frame indicates that the information associated with the SCS agreement has not been transferred, wherein the processor is further configured to establish a different SCS agreement with the second AP upon roam.

8. The STA of claim 1, wherein the processor is further configured to receive, from the first AP, a frame indicating that the first AP is capable of transferring the information associated with the SCS agreement as part of roaming.

9. A first access point (AP) in a wireless network, comprising:
a memory; and
a processor coupled to the memory, the processor configured to:
receive, from a station (STA), a first frame that causes a transfer, from the first AP to a second AP, information associated with a stream classification service (SCS) agreement;
transfer, to the second AP, the information associated with the SCS agreement; and
transmit, to the STA, a second frame that includes a response to the first frame.

10. The first AP of claim 9, wherein the SCS agreement includes quality of service (QOS) characteristics for traffic of the STA or one or more information items in a traffic classifier (TCLAS) element.

11. The first AP of claim 9, wherein the second frame indicates a time during which the STA switches to the second AP.

12. The first AP of claim 9, wherein the processor is further configured to transmit, to the STA, a frame indicating that the first AP is capable of setting up or initiating a transfer of the information associated with the SCS agreement.

13. The first AP of claim 9, wherein the first frame indicates that the information associated with the SCS agreement can be transferred or requests that the information associated with the SCS agreement be transferred to the second AP.

14. The first AP of claim 9, wherein the second frame indicates that the information associated with the SCS agreement has been transferred or that the information associated with the SCS agreement will be transferred upon roam.

15. The first AP of claim 9, wherein the second frame indicates that the information associated with the SCS agreement has not been transferred.

16. The first AP of claim 9, wherein the processor is further configured to transmit, to the STA, a frame indicating that the first AP is capable of transferring the information associated with the SCS agreement as part of roaming.

17. A first access point (AP) in a wireless network, comprising:
a memory; and
a processor coupled to the memory, the processor configured to:
receive, from a second AP, a first frame that causes a transfer, from the second AP to the first AP, information associated with a stream classification service (SCS) agreement between the second AP and a station (STA);
transmit, to the second AP, a second frame that includes a response to the first frame; and
receive, from the STA, one or more frames according to transferred information associated with the SCS agreement.

18. The first AP of claim 17, wherein the SCS agreement includes quality of service (QOS) characteristics for traffic of the STA or one or more information items in a traffic classifier (TCLAS) element.

19. The first AP of claim 17, wherein the second frame indicates a time during which the STA switches from the second AP to the first AP.

20. The first AP of claim 17, wherein the second frame accepts the transfer of the information associated with the SCS agreement.
